(19) United States
(12) Patent Application Publication
(10) Pub. No.: US 2003/0131070 A1
(43) Pub. Date: Jul. 10, 2003

(54) Customization of information from web sites

(75) Inventors: Michael Stroebel, Groebenzell (DE); Markus Stolze, Adliswil (CH); Dieter Jaepel, Richterswil (CH)

Correspondence Address: IBM CORPORATION, INTELLECTUAL PROPERTY LAW DEPT., P.O. Box 218, YORKTOWN HEIGHTS, NY, 10598, US

(73) Assignee: International Business Machines Corporation, Armonk, NY

(21) Appl. No.: 10/260,605

(22) Filed: Sep. 27, 2002

(30) Foreign Application Priority Data
Jan. 10, 2002 (EP) 02000557.5

(51) Int. Cl. G06F 15/16

(52) U.S. Cl. 709/217

(57) ABSTRACT

Methods and apparatus are provided to facilitate customization of information presented by web sites for display to an Internet user based on his preferences. In a customization system connectable to web sites via the Internet, a user specification is stored in response to input of the Internet user. The user specification comprises data which indicates, for each of a plurality of predefined preference elements, each of which may have a plurality of predefined values corresponding to respective user preferences, a value corresponding to the user's preference. On establishment of a connection by the Internet user to any one of a plurality of web sites, at least some of the user specification data is supplied to the web site by the customization system. When the user establishes the connection to the web site, at least some of the prestored user specification data is supplied to the web site. Web sites which are able to interpret the specification data can thus use the data to customize the user's web session according to the particular user preferences indicated by the data supplied. Since the preference elements and associated values for expression of user preferences are predefined, web sites can be configured to interpret the specification data based on the known elements and values and use the expressed preferences in their customization processes. The user specification can also be updated in response to information received from a web site indicative of new user preferences expressed during connection of the user to that site.

### FIELD OF THE INVENTION

This invention relates generally to customization of information presented by web sites for display to Internet users. Embodiments of the invention provide methods and apparatus which facilitate such customization by web sites, and systems which utilize these methods and apparatus.

### BACKGROUND

At present, web sites use various schemes to provide some level of customization, or adaptation to individual Internet users, of the information displayed to users during web sessions. On-line shopping sites in particular commonly use some type of customization system. For example, where a user has visited the site previously, various personal and historical information, such as the user's name, account activity, payment method, etc., may be stored at the site. This can be retrieved when the user next visits the site and used to personalize the web session, for example to welcome the user by name. Where historical information stored by a web site includes previous shopping behavior or click history, this can be used to customize advertising, for example to promote add-ons to past purchases. In some cases, users may be classified based on personal or historical information, and recommendations may be made based on the purchasing statistics of all users in the same class, e.g. “Other people who bought this also liked . . . ”. Where interviewing techniques are used for filtering purposes to assist users with product selection (e.g. “Do you want your computer for business or private use?”), this provides a real-time customization tool in that further questions and product suggestions are typically adapted to the answers given by the user.

In general, the objective of these customization mechanisms is to guide the user towards relevant purchases, whether by supporting selection of the right product for that user or promoting products of potential interest to the user, based on information supplied by the user during visits to the web site. While these mechanisms can be useful to users, there are nonetheless a number of problems from the user's point of view. For example, users often like to “shop around”, visiting a number of different web sites before making purchasing decisions. Each time the user visits a new web site, the information gathering process necessary for operation of customization mechanisms must be undergone again. It can then take some time before the customization mechanisms are effective, and the information gathering process itself can be tedious for the user. In addition, there is no way for the web site to detect when a user is shopping from a different perspective to previous visits to the site. If the historical information used for customization is based on past visits where the user was shopping for products for one person, then this information is likely to be inapplicable when the user visits the site to make a purchase for someone else. For example, if a user has to-date used an on-line bookstore to buy books for his daughter, and now visits the site to search for work-related literature, then recommendations for the latest children's bestsellers will be unhelpful, if not irritating. The customization measures here are not only ineffective, but counterproductive. While real-time customization based on click-through clustering (as with the adaptive interviewing techniques mentioned above for example) avoid this problem to some extent, the customization process here is somewhat crude and error-prone, particularly at the beginning of a shopping session when little information is available on which to base the customization. A further problem with existing schemes is that customization-relevant information supplied by a user when shopping from a given perspective is associated with that user only, and cannot be used by any other user with exactly the same perspective, e.g. shopping for a gift for the same person.

The fact that on-line shoppers may adopt various different perspectives, or roles, according to the nature or intended recipient of the product sought is accommodated to some extent by some web sites. For example, the CNET Buying Advisor system (computers.cnet.com/hardware/0-4880256-7-1475743.html?tag=st.co.2645860-7-1441247.more. 4880256-7-1475743) allows a user to select from a set of offered roles, e.g. “hard-core gamer”, for which general user preferences are predefined in the system, to assist the user in identifying the right desktop computer. The CDNOW gift guide system (www.cdnow.com/cgi-bin/mserver/SID=1073887240/pagename=/RP/GC/gc_guidehub.html) similarly offers a choice of predefined roles, e.g. “Teen Pop Princess”, to assist with music selection. These systems effectively assign users to a generalized class based on their selection from the offered roles. The SmarterKids site for children's educational toys (www.smarterkids.com) recognizes that parents may shop for more than one child and thus allows users to maintain a profile for each of the children they buy for. Different types of products are then offered based on the cognitive style indicated by the profile for each child. The customization processes in these systems are still inherently localized, however, the user information supplied for customization purposes being usable only at the individual site. Users wishing to visit other sites must undergo the information gathering process required at each site for operation of any customization facilities provided by the site.

In the customization systems described above, information supplied by the user is recorded at the web site and used for the purpose of customizing web sessions according to user preferences indicated by the information supplied. In the different field of personal data security, it is known for personal user data, such as credit card details, address, date of birth etc., to be stored independently of web sites for use by different web sites visited by the user. In particular, PrivacyBank.com (www.privacybank.com) provides a service where such personal user data, entered in form fields at various web sites, is stored in a PrivacyBank profile for the user. This data can be supplied, at the user's request, to individual web sites for filling in on-line forms at the site if P3P security requirements are deemed to be met. P3P (Platform for Privacy Preferences—www.w3.org/P3P/) is a standard security protocol whereby users can specify security requirements which are stored on the user's PC and indicate what security guarantees are required of web sites for personal user data to be used by the web site. Web sites maintain a policy specifying the guarantees given, and this policy is supplied to an agent on the user's web browser which checks the policy against the user's security requirements, warning the user if the requirements are not met before the user supplies any personal data. Early P3P proposals envisaged supply of personal user data prestored on the user PC, though the current P3P protocol does not provide for transport of the user data—hence the data handling service provided by PrivacyBank.com. P3P also includes the abstract concept of a persona though this is described as a broad concept only. Thus, the PrivacyBank.com service complements the P3P data privacy provisions, providing a personal data profile for each user, for use within the standard privacy protection framework, from which the user can transfer data for completing on-line forms at web sites. PrivacyBank.com also allows authorized sharing of personal user data with other PrivacyBank.com members. Overall, however, the nature and purpose of this data-privacy scheme is quite different to the customization systems described above, where web sessions are customized based on user preferences indicated by information supplied by the user. A system similar to the PrivacyBank scheme is also provided by the DigitalMe service (www.digitalMe.com). Here, a user can set up one or more “Me Cards” in which various personal data required by on-line forms encountered at web sites (e.g. name, address, passwords, favorite color, shoe size, preferred airline) can be stored. Information stored in these Me Cards can then be sent, when prompted by the user, to other users for their information or to web sites for filling in on-line forms provided at the site. In the latter case, like the PrivacyBank system, the user reviews the form for information already stored in a Me Card, and can select a “send” option to send this information for use in the form. Again, however, the nature and purpose of this scheme is quite different to the customization systems described earlier.

### SUMMARY

According to one aspect of the present invention there is provided a method of facilitating customization of information presented by web sites for display to an Internet user based on preferences of the Internet user, the method comprising:

storing, in response to input of the Internet user, a user specification comprising data which indicates, for each of a plurality of predefined preference elements, each of which may have a plurality of predefined values corresponding to respective user preferences, a value corresponding to that user's preference; and

on establishment of a connection by the Internet user to any one of a plurality of web sites, supplying at least some of the user specification data to the web site to allow the information presented for display to the user by the web site to be customized based on the user preferences indicated by the data supplied.

With methods embodying the present invention, therefore, a user specification is stored for an Internet user independently of web sites visited by the user. This user specification comprises data indicative of preferences of the user which are selected via user input. These preferences are expressed in terms of a predefined data structure defining a plurality of preference elements and, for each preference element, a plurality of values corresponding to respective possible user preferences. For each preference element, at least one value corresponding to that user's preference is stored in response to user input. When the user establishes a connection to any one of a plurality of web sites, at least some of the prestored user specification data is supplied to the web site. Web sites which are able to interpret the specification data can thus use the data to customize the user's web session according to the particular user preferences indicated by the data supplied. Since the preference elements and associated values for expression of user preferences are predefined, web sites can easily be configured to interpret the specification data based on the known elements and values and use the expressed preferences in their customization processes. Embodiments of the invention thus provide a convenient and effective system whereby a user can define a personal user preference specification which can be used by multiple web sites to customize sessions to that user's preferences based on the predefined preference elements and associated values.

The predefined data structure for user preference selection may range, for example, from a simple list of preference elements and their associated values to a sophisticated ontology defining a more complex organization of preference elements and values and the relationships which hold between them. For example, such an ontology may define a hierarchical organization of different categories, subcategories, sub-subcategories etc. of preference elements. Here, preference elements can be organized within the data structure in different categories corresponding to different areas of user interest (e.g. clothes, books, music, make-up etc.), with a set of preference subcategories for each (e.g. sportswear, work wear, formal wear, etc.), each subcategory having its own subcategories (e.g. type, brand, fabric, etc.), and so on. A user may indicate his preferences over as much or as little of the available data structure as he wishes, the results being recorded in the user specification. In the user specification, the preference elements themselves and the values assigned to these elements may be defined in any desired manner which enables each element and its assigned value to be identified. For example, preference elements may be expressed in <name, value> form in the user specification, where the “name” component indicates the identity of the preference element (e.g. the particular category or subcategory of the data structure to which the preference element corresponds), and the “value” component indicates the particular preference value selected by the user. As a simple example, in a category relating to general likes and dislikes (“taste”), for a subcategory “favorite color” with possible values “yellow”, “green”, “blue”, etc., the user may select “blue”, resulting in a <name, value> element of <Taste.Colour, blue> in the user specification. Of course, the user may be able to select more than one preference value for a given preference element where appropriate.

The user will typically input his preference selections via a user interface displayed at the user station (a user PC, PDA (Personal Digital Assistant) or other user device for accessing the Internet) which guides the user through the preference elicitation process. Thus, while scenarios might be envisaged where such a user interface is provided independently, methods embodying the invention preferably include the step of providing a user interface, for display at a user station, for prompting the user input required to produce the user specification.

While basic embodiments of the invention provide for storage and use at multiple web sites of a single user specification for a user, methods embodying the invention preferably include the steps of: storing a plurality of said user specifications in response to input of the Internet user, each of the user specifications representing a different set of user preferences for that user; and selecting, in response to input of the Internet user, one of said plurality of user specifications for use by that user; wherein the user specification data supplied to the web site on establishment of said connection is data of the selected user specification. Here, therefore, more than one user specification is stored for a user, with the user selecting the particular user specification he wishes to use for a given web session. Each user specification can reflect a different perspective or role which the user may wish to adopt when visiting web sites. For example, one user specification may correspond to a user's role as the father of a teenage girl, and another to his role as an agent in a purchasing department. The user can thus select the specification corresponding to the desired role for a web session, ensuring that the customization measures implemented by a web site are relevant to his current purpose.

Methods embodying the invention could be implemented by control logic provided in the user station, for example by an application which plugs in to the user's web browser. However, to avoid the need for specialized technology at the user station, in particularly preferred embodiments the method is implemented by a remote proxy server via which the user connects to web sites. When implemented in this manner, methods embodying the invention include the steps of: receiving the input of the Internet user from a remote user station; establishing said connection in response to receipt from the user station of a web site request corresponding to a said web site; receiving said information for display to the user from the web site; and forwarding the information to the user station for display. In another possible arrangement requiring only minor additional functionality at the user station, methods embodying the invention may be implemented by a remote server which can be accessed from a user station for the necessary user input and, when a user connects to a web site independently of the remote server, can be accessed by the web site to retrieve the specification data for the user. With this implementation, methods embodying the invention include the steps of: receiving the input of the Internet user from a remote user station; and, on establishment of said connection, supplying said user specification data to the web site in response to receipt from the web site of a user specification request identifying the Internet user. Examples of these remote server arrangements will be described in more detail below, but each arrangement allows convenient operation of the system as a service for multiple Internet users. Of course, more than one user might also be catered for in embodiments implemented locally at a user station since user devices are often shared by more than one individual. In any case, methods embodying the invention preferably provide for storage of user specifications for more than one user, the appropriate user specification data being supplied to a web site to which a given user connects.

Depending on the particular arrangement, embodiments can be envisaged where the user specification data is supplied to a web site with the connection request following input by the user of the web site URL. In such cases, the specification data could simply be supplied to all web sites to which the user connects. However, not all web sites may be configured to use the specification data, and the specification data is preferably supplied only to those web sites which are so configured. Such web sites may issue a request for user specification data when a connection has been established by the user, the data being supplied to a web site in response to receipt of such a user specification request. In some embodiments, all of the user specification data could be supplied to the web site. For greater efficiency, however, the user specification requests preferably indicate the particular preference elements for which user preference values are requested, the user specification data supplied by way of response then indicating the requested preference values.

Methods embodying the invention preferably also include the step of updating the user specification in response to information received from a web site indicative of new user preferences expressed during connection of the user to that site. Such new user preferences may be identified in various ways as discussed further below. User specifications can thus be continually refined as new preferences are expressed during web sessions. The user specification may also include additional data, such as personal user details and/or browsing history data, which may be of use to web site customization systems. In particular, methods embodying the invention may include the steps of: receiving from a web site information indicative of user actions (purchases made, transactions generally, clicks, etc. .) during connection of the user to that site; and storing user-history data, indicative of these user actions, in the user specification. The user-history data is thus made available for use by web sites in subsequent sessions.

Preferred methods also allow user specifications to be shared with other authorized users. In particular, preferred methods include the steps of associating a security token such as a password with the user specification stored for a user, and, on input of the security token by another user and establishment of a connection to a web site by that other user, supplying to the web site at least some of the user specification data of the user specification associated with the security token.

A second aspect of the present invention provides a method of customizing information presented by a web site for display to an Internet user based on preferences of the Internet user, the method comprising:

in a customization system connectable to the web site via the Internet, storing, in response to input of the Internet user, a user specification comprising data which indicates, for each of a plurality of predefined preference elements, each of which may have a plurality of predefined values corresponding to respective user preferences, a value corresponding to that user's preference, and, on establishment of a connection by the Internet user to the web site, supplying at least some of the user specification data to the web site; and

at the web site, customizing the information presented for display to the user based on the user preferences indicated by the user specification data supplied by the customization system.

A third aspect of the present invention provides apparatus for facilitating customization of information presented by web sites for display to an Internet user based on preferences of the Internet user, the apparatus comprising memory, communications circuitry for communication of data with web sites, and control logic, the control logic being configured to:

generate, in response to input of the Internet user, a user specification comprising data which indicates, for each of a plurality of predefined preference elements, each of which may have a plurality of predefined values corresponding to respective user preferences, a value corresponding to that user's preference;

store the user specification in said memory; and

on establishment of a connection by the Internet user to any one of a plurality of web sites, supply at least some of the user specification data to the web site via said communications circuitry to allow the information presented for display to the user by the web site to be customized based on the user preferences indicated by the data supplied.

It is to be understood that, in general, where features are described herein with reference to a method embodying the invention, corresponding features may be provided in apparatus embodying the invention, and vice versa.

A fourth aspect of the present invention provides apparatus for customizing information presented by a web site for display to an Internet user based on preferences of the Internet user, the apparatus comprising:

a customization system connectable to web sites via the Internet, the customization system comprising memory, communications circuitry for communication of data with web sites via the Internet, and control logic configured to generate, in response to input of the Internet user, a user specification comprising data which indicates, for each of a plurality of predefined preference elements, each of which may have a plurality of predefined values corresponding to respective user preferences, a value corresponding to that user's preference, to store the user specification in said memory, and, on establishment of a connection by the Internet user to any one of a plurality of web sites, supply at least some of the user specification data to the web site via said communications circuitry; and

a server system providing one of said plurality of web sites, the server system being arranged, on establishment of a connection by the Internet user to that web site, to customize the information presented for display to the user based on the user preferences indicated by the user specification data supplied by the customization system.

The invention also provides a computer program element comprising computer program code means which, when loaded in a processor of apparatus for facilitating customization of information presented by web sites for display to an Internet user, configures the processor to perform a method as hereinbefore described.

### BRIEF DESCRIPTION OF THE DRAWINGS

Embodiments of the invention will now be described, by way of example, with reference to the accompanying drawings in which:

FIG. 1 is a schematic block diagram illustrating the overall configuration of a system embodying the invention for customization of web sessions;

FIG. 2 is a schematic block diagram illustrating an embodiment of the shopping gate in the FIG. 1 system;

FIG. 3 is a flow chart illustrating operation of the shopping gate for set-up of user specifications;

FIG. 4 is a flow chart illustrating operation of the shopping gate during a typical web session;

FIG. 5 shows a modification to the process of FIG. 4;

FIG. 6 is a flow chart illustrating the operation of a web site server system for customizing web sessions based on information supplied by the shopping gate; and

FIG. 7 is a schematic block diagram showing the overall configuration of a system employing an alternative shopping gate embodying the invention.

### DESCRIPTION OF PREFERRED EMBODIMENTS

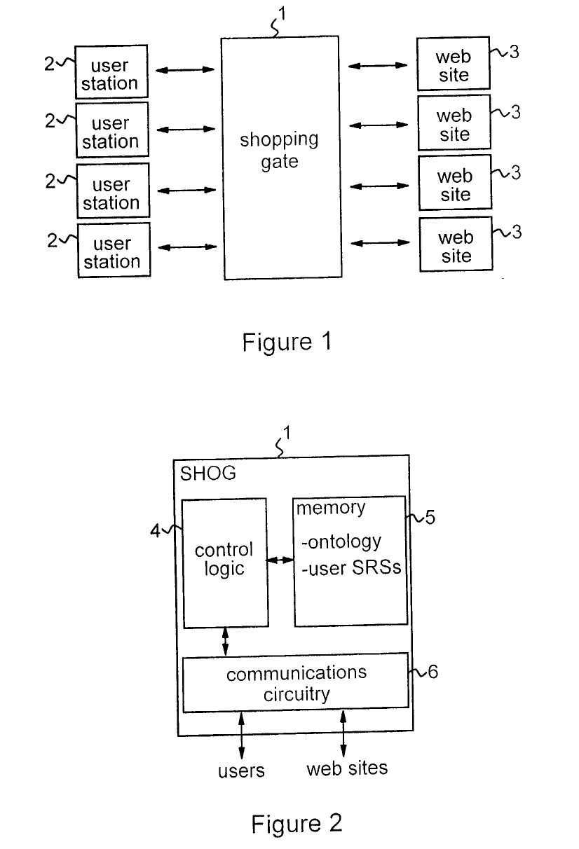

The particular embodiments described in detail hereinafter focus on facilitating customization of web sites in the context of on-line shopping. In the overall arrangement of FIG. 1, a customization system in the form of “shopping gate” 1 is implemented as a remote proxy server. (While shopping gate 1 is illustrated as a single block in the figure, in general of course a system of one or more servers may be employed to implement the shopping gate). Users can access the Internet via shopping gate 1 by configuring their web browsers at user stations 2 (PCs, PDAs, etc.) to use the shopping gate as their proxy server. Users can thus connect via shopping gate 1 to Internet web sites indicated schematically at 3, each implemented in the usual manner by a server system comprising one or more servers.

Shopping gate 1, which may be implemented for example by IBM's WBI programmable web proxy, is configured to perform the customization facilitation processes described below in addition to the usual functions of a remote proxy server. The schematic of FIG. 2 illustrates the main components of the shopping gate 1 involved in operation of these processes. As illustrated, the shopping gate (SHOG) 1 comprises control logic 4, memory 5, and communications circuitry 6 via which the SHOG communicates with user stations 2 and web sites 3. Control logic 4 implements the customization facilitation processes described in detail hereinafter. In general, control logic 4 may be implemented in hardware or software or a combination thereof, but will typically be implemented by a processor running software which configures the processor to perform the functions described. While the processor here may be preconfigured with appropriate software, the program code constituting such software could be supplied separately for loading in the SHOG server to configure processor to operate as described. Such program code could be supplied as an independent element or as an element of the program code for a number of control functions, and may be supplied embodied in a computer-readable medium such as a diskette or an electronic transmission sent to a system operator. In any case, suitable software will be apparent to those skilled in the art from the description herein.

The customization facilitation processes implemented by control logic 4 include the generation and maintenance of user specifications, or “shopping role specifications” (SRSs), for users, the supply of user interfaces for display at user stations 2 to elicit user input, and interaction with web sites 3 in accordance with a predefined “SHOG interaction protocol”. In this embodiment, the SHOG interaction protocol uses the standard HTTP protocol for Internet communications but augmented to provide for communication of SRS data and requests as described further below. The SHOG interaction protocol is transparent to web sites which are not configured to utilize the shopping gate's facilities for their customization processes, but is known to “SHOG-enabled” web sites which are configured to take advantage of these facilities.

The user SRSs are generated by the control logic in response to user input and indicate user preferences in terms defined by an ontology stored in memory 5. This ontology comprises a data structure defining a hierarchical organization of preference elements. Each preference element represents a particular type of user preference, and for each preference element a plurality of values, corresponding to respective possible user preferences, are defined in the ontology. The data structure is hierarchical in that preference elements are organized in categories, subcategories, sub-subcategories etc. corresponding to different areas of user interest as described earlier. Thus, preference elements may be defined to indicated the user's preference for certain product categories, and, within each of these categories, to indicate more detailed preferences, and so on. For example: a preference element “Needs” corresponding to the general category of product needs may have possible values corresponding to clothes, books, music, make-up, etc.; a preference element “Needs.Clothes” corresponding to the clothes subcategory here may have possible values corresponding to sportswear, work wear, formal wear, etc.; and preference elements may then be defined for the sportswear subcategory here to indicate preferences for type, brand, fabric, etc., and so on. Overall, the ontology may cover a wide range of user preferences including: general tastes and high-level interests; user needs in terms of types of products (whether goods or services); particular attributes of product types and products; and preferred values or value ranges (where ranges may be used for numerical information such as delivery time etc.) for these attributes. Overall the purpose of the ontology, which may be formulated on the basis of known XML (Extensible Mark-up Language) schema (www.w3.org/XML/schema/), is to provide a predefined basis for expression of user preferences in the user SRSs, allowing SHOG-enabled web sites, which have access to this ontology, to request syntactically and semantically correct data in the process described below, and to operate their customization processes based on the data received. In addition to definition of the preference elements and associated values, the ontology here also defines the format for additional data which may be included in user SRSs, such as personal user details, browsing history data, and evaluation criteria, or utility functions, as discussed further below.

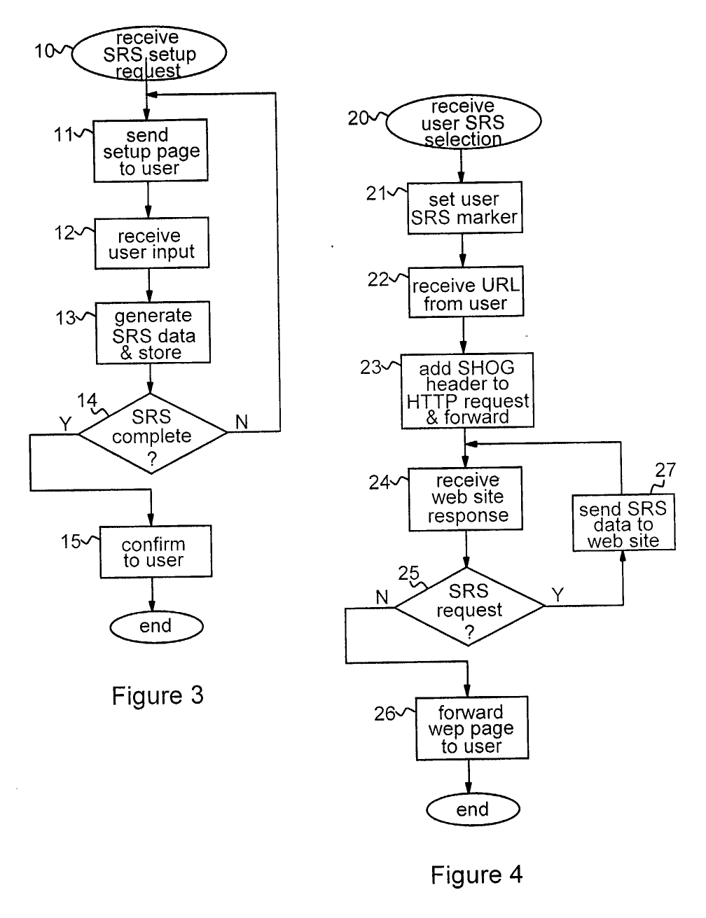

In operation when a user is connected to the shopping gate 1, the control logic 4 can supply to the user station 2 various user interfaces in the form of web pages for eliciting the user input required for operation of the system. For example, on initial connection, control logic 4 may supply a welcome page giving various options such as setup of new SRSs, viewing or modifying existing SRSs, and authorizing sharing of SRSs with other users. The process for setting up a new SRS is illustrated in FIG. 3 and begins, as indicated by step 10 in this figure, when an SRS setup request is received from the user following selection of the SRS setup option on the welcome page. In step 11, control logic 4 then sends the first setup page to user station 2, inviting the user to input, for example, personal details such as address, date of birth, clothing sizes, etc. . , and/or his preference selections corresponding to an initial stage of the preference hierarchy defined in the ontology. The resulting user input is received at step 12, and in step 13 the input is processed to generate SRS data in the format defined by the ontology, this data then being stored in memory 5 as part of the SRS for that user. In step 14 the control logic checks whether the SRS is complete, e.g. because the user terminates the setup process or all relevant preferences defined in the ontology have been dealt with. If not (“No” at step 14), operation reverts to step 11 where the next setup page is sent to the user station. This page will generally determined based on the user preferences indicated in the previous page to invite input corresponding to the appropriate next stage of the preference hierarchy defined in the ontology. Operation continues in this way, the user indicating his preference selections on successive setup pages which progress through successive categories, subcategories etc. of the hierarchical data structure. When this process is deemed to be complete at step 14 (“Yes” here), the control logic confirms successful setup to the user in step 15. The complete SRS has now been stored in memory 5, the user having worked through as much or as little of the preference hierarchy as desired.

User preferences may be expressed in the SRS in the form of <name,value> elements, with the “name” component identifying the particular preference element (e.g. “Needs.Clothes”), and the value component indicating the particular user preference value selected, (e.g. “Sportswear”). These <name,value> elements may allow for expression of more than one user preference value for a given element where appropriate. With an ontology based on XML schema as described above, the SRS itself may be presented as an XML document instance, conforming to the overall data schema, and can be created (and edited) by control logic 4 using a standard XML document editor.

Using the above process, users can thus setup one or more personalized SRSs corresponding to different roles they may adopt when shopping online. When a user wishes to shop on the Internet, he can select the SRS appropriate to his current role. In particular, having connected to the shopping gate 1, the user selects from the welcome page the “choose SRS” option, whereupon the control logic 4 serves up a page indicating the current SRSs stored for that user, for example by displaying role names previously set by the user for his SRSs. The subsequent operation of the system through a user web session is indicated in FIG. 4.

The FIG. 4 process begins at step 20 when control logic 4 receives the user's input choosing an SRS to be used for the session. In step 21 the chosen SRS for that user is selected by the control logic, here by setting a marker against the appropriate user SRS in memory 5. In step 22 the control logic receives a web page request input by the user in the usual way by entering a URL at user station 2. In step 23 the control logic augments the received HTTP request with a SHOG header, and forwards the request to the target web site 3. The SHOG header here simply serves to indicate to SHOG-enabled web sites that SRS data is available for this user. The web site response is received by control logic 4 at step 24. If the web site is not SHOG-enabled, it will simply respond in the usual way by returning the requested web page to the shopping gate. However, in accordance with the SHOG interaction protocol discussed above, SHOG-enabled web sites respond by sending the shopping gate a user specification request (SRS request) which specifies the particular SRS elements the merchant is interested in. This SRS request specifies the required elements in the format defined in the SHOG ontology, and thus may specify one or more preference elements for which user preference values recorded in the SRS are required. In particular, the SRS request may be an XML document instance, conforming to the SHOG ontology, which is added as an XML stream to the HTTP header information. This document can specify particular preference elements by name with empty value domains (placeholders) for the required values. In step 25 of FIG. 4 the control logic thus checks whether the response from the web site is an SRS request. If not (“No” at step 25), i.e. the web site is not SHOG-enabled, the received web page is simply forwarded to the user at step 26 in the usual manner. However, if an SRS request is identified (“Yes” at step 25) then the requested SRS data (if available in the user SRS) is sent to the web site at step 27. In particular, the placeholders in the SRS request can be replaced by the appropriate values from the user SRS, the result being added to the original HTTP request and returned to the web site. Operation then reverts to step 24 where the further response from the web site is received. This may be a further SRS request if the interaction protocol so allows, whereupon operation proceeds again through steps 25 and 27. However, when the web site returns a web page, this will be identified by the control logic at step 25, and the web page is then forwarded to the user at step 26. The process is then complete and the control logic awaits further user input. If this is a new HTTP request, operation will revert to step 22 for the new URL, but the user can at any time select a different SRS to reflect a change of shopping role, whereupon operation begins again at step 20.

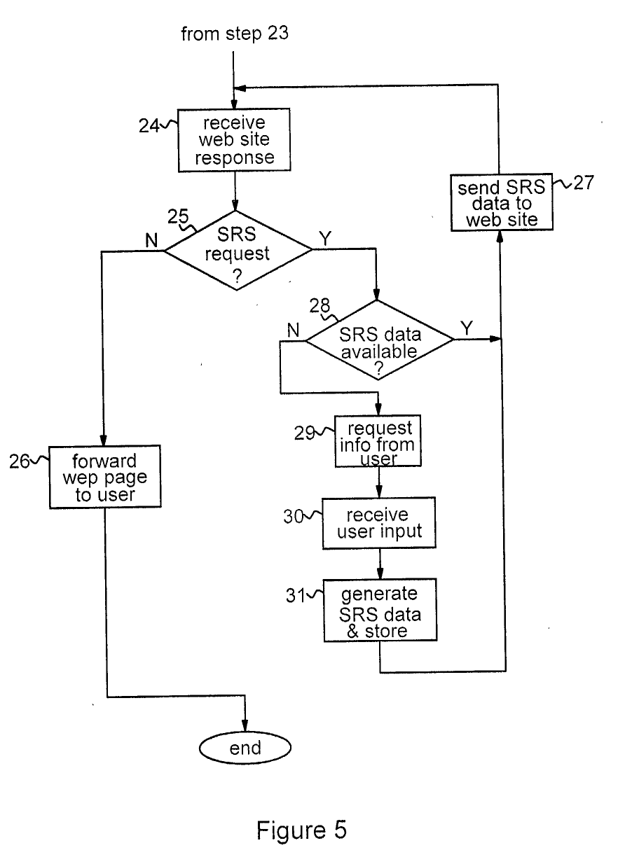

In step 27 of the FIG. 4 process, SRS data requested by a web site is forwarded to the site only if available in the current user SRS. FIG. 5 shows a modification to this process where further information can be requested from the user. For simplicity, FIG. 5 shows the process from step 24 onwards, the earlier steps corresponding to steps 20 to 23 of FIG. 4. Here, when an SRS request is identified at step 25, control logic 4 proceeds to check, in step 28, whether the requested data is available in the current user SRS. If so, the required data is forward in step 27 as before. If not, however, in step 29 the control logic sends a request to the user station inviting the user to input the required information. The user input is received at step 30 and at step 31 the control logic updates the user SRS in memory 5 to reflect the new information. Operation then proceeds to step 27, where the new SRS data is sent to the web site, and the process continues as before. As an alternative to this process, in other embodiments the SRS request sent by a web site could be presented as an HTML page with form fields for input of the required SRS data. In these embodiments, if the required data is not available in the current user SRS, the control logic can use the HTML page created by the web site to request the information from the user.

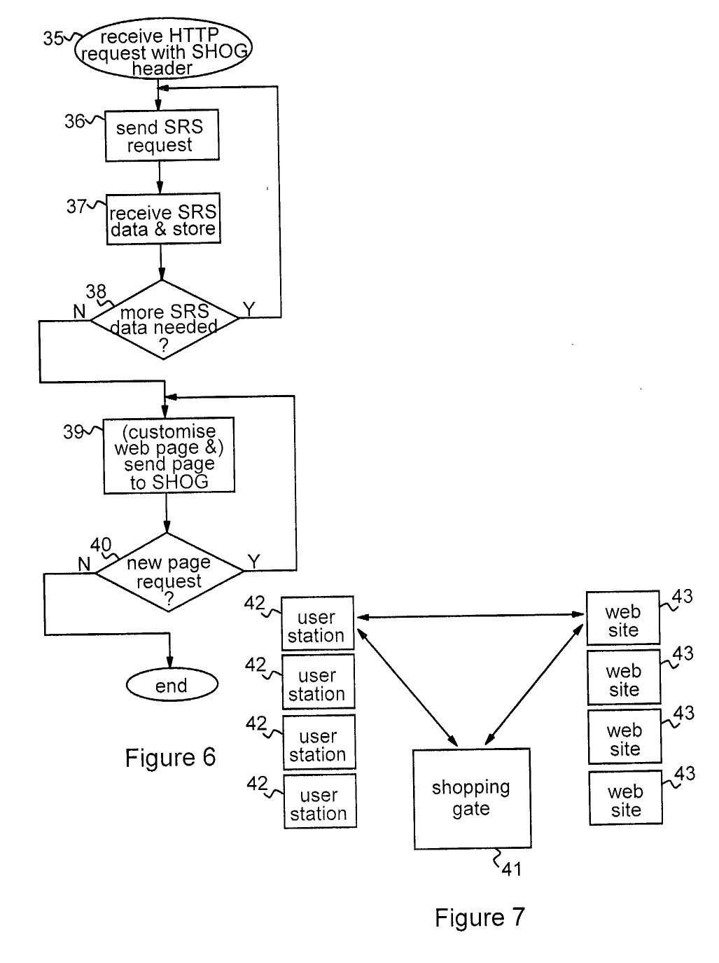

FIG. 6 illustrates operation of a SHOG-enabled web site for the interaction protocol implemented in FIG. 4. The HTTP request with SHOG header is received by the web site at step 35, and in step 36 the SRS data required for that site's customization mechanisms is requested from shopping gate 1 as described above. The SRS data returned by the shopping gate is received and stored at step 37, and in step 38 it is then decided whether any further SRS data is required, for example based on the SRS data received thus far. If so (“Yes” at step 38), then operation reverts to step 36. Once all the required SRS data has been received, this data can be used by the site's customization mechanisms to customize web pages sent to the user during the web session in accordance with user preferences indicated by the SRS data received. For example, adverts, site content information, etc. presented in initial web pages can be tailored to the user's preferences. Further web pages supplied as the user navigates the site can similarly be tailored to particular products, product types etc., in which the user is known to be interested. In any case, following receipt of the required SRS data (“No” at step 38), in step 39 the requested web page (customized if appropriate) is sent to the shopping gate for forwarding to the user, and a new HTTP request for that user is awaited in step 40. If a new page request is received here (“Yes” at step 40), operation reverts to step 39. If not (“No” at step 40), e.g. after a predetermined time interval, the session is deemed to be ended and the process terminates.

In a modification to the FIG. 6 process which recognizes that web sites may wish to request SRS data gradually as a user navigates the site, operation reverts from step 40 “Yes” back to step 38 of FIG. 6. Here, therefore, when a new page request is received at step 40, it is then determined at step 38 whether new SRS data is required to customize that page in accordance with the customization processes provided at the site. If so, operation reverts to step 36 as before where the new SRS data is requested from the shopping gate. If not, operation simply proceeds to step 39 and the requested web page is forwarded as before.

Aside from the basic customization facilitation processes described above, various additional functionality is preferably provided in systems embodying the invention. In particular, SHOG control logic 4 is preferably configured to implement the standard P3P privacy protocol, allowing the user to store his privacy requirements for all, or individual, SRSs. Here, the control logic will check web sites' privacy policies in the manner of a P3P user agent, and only supply SRS data where these policies meet the user's privacy requirements. SHOG-enabled web sites can supply their P3P policy information as part of SRS data requests. Further, control logic 4 is preferably configured to update user SRSs in response to receipt of relevant information from web sites. In particular, SRSs can be updated based on information indicative of newly-identified user preferences within the scope of the SHOG ontology. In addition, the control logic may supplement SRSs with user-history data indicative of user actions (purchases made, transactions generally, click history, etc.) during web sessions. In one scenario, where the shopping gate operates as a proxy server as above, the control logic 5 can be configured to monitor HTTP traffic between the user and web site during the web session, identifying relevant preference and user-history information from this traffic, and recording this in the current user SRS in the appropriate format defined by the SHOG ontology. To reduce the processing burden on the shopping gate, however, SHOG-enabled web sites are preferably configured to record user-history and preference information within the scope of the ontology during web sessions. At the end of the user session, this can then be relayed to the SHOG to update the user SRS. Web sites may record relevant information as the session progresses, for example as an XML file, and allow the user to view a “role-updates page” before leaving the site and indicate whether he wishes the information to be used to update his current SRS. If so, the web site can send the file to the shopping gate 1 whereupon new information, whether new history data, additional user preferences or changes to existing user preferences) is added to the SRS by control logic 4. Alternatively, the control logic may request the updates file automatically when the user leaves a SHOG-enabled site.

A further feature offered by shopping gate 1 above is the facility for users to share their SRSs with other, authorized, users. Here, by selecting a “share roles” option from the welcome page for example, a user may name authorized persons and/or select a password for authorized use by other persons of one or more of his SRSs. Control logic 4 can then record such an authorized user name or password as a security token associated with the relevant SRS or SRSs. When the appropriate security token is then input by another user, the control logic will utilize the associated SRS for web sessions of the authorized user. This allows a user who has established an effective SRS for a particular role to share the SRS with another person who may wish to shop in the same role. If desired, SRS update mechanisms may be disabled during authorized SRS user sessions, for example at the option of the SRS originator, to allow users to maintain control over refinement of their own SRSs.

As mentioned earlier, SRSs generated by control logic 4 may include not only user preference information, personal details and history data, but also evaluation criteria. These evaluation criteria may define expressions or formulas for evaluating products offered by web sites in relation to the known user preferences, thus providing a mechanism to judge the relative suitably of products to the user. Such evaluation criteria may be derived automatically by control logic 4 based on user input during SRS setup and new information gathered during SRS use. Evaluation criteria may be expressed, for example, as “utility functions” which assign merit values to product features or combinations of product features, based on user preferences. As a simplistic example, a utility function for cars might take the form: “If manufacturer=XYZ and color=red, then utility=10”. Application of relevant utility functions, alone or in combination, to offered products then enables an overall utility score to be obtained indicating the degree of suitability of the product to the user. Where evaluation criteria may be applied in combination, weighting factors may be applied to individual criteria to indicate their relative importance to the user and provide improved accuracy in the utility assessment process. In any case, the product evaluation process may be performed by the control logic for products identified in web pages, the results being displayed to the user as an additional service. In this case, utility functions stored in SRSs may be excluded from SRS data made available to web sites. Alternatively, utility functions could be provided to web sites along with other SRS data for use in the customization processes of the site.

Users may at any time access their SRSs to view and modify the role defining information. In addition, the control logic preferably also allows new SRSs to be generated by combining, or “cascading”, existing SRSs, whether of that user or another user who has provided the necessary authorization. For example, a user may cascade one SRS defining a personal role with another SRS set up by his daughter, taking essential preferences from his daughter's SRS but overriding other preferences (relating to price for example) and modifying evaluation criteria (for example to emphasize quality). Also, in general when setting up SRSs, the control logic may allow a user to flag some SRS relevant information as limited to the current role, and other information as applicable also to other roles of the same user. As a further option, a number of predefined SRSs may be stored in memory 5 for use by any user, these SRSs corresponding to standard roles and being based on collected, statistical buying behavior.

A particular advantage of the proxy-based shopping gate arrangement described above is that it does not require specialized browser technology at the user station: all web browsers that allow specification of a remote proxy can be used in the system. Alternative arrangements can be envisaged, however, and a particular example is illustrated in FIG. 7. Here, a shopping gate 41 is implemented as a simple HTTP server that does not need to mediate all the HTTP requests of users. In particular, the construction and operation of shopping gate 41 corresponds generally to that of shopping gate 1 described above, but here users establish connections to web sites independently of the shopping gate. Shopping gate 41 still provides for storage and maintenance of SRSs as described above, and before commencing a web session users still access the SHOG via user station 42 to select a required SRS. A local proxy or browser plug-in at a user station 42 is employed to augment HTTP requests with a SHOG header, and SHOG-enabled web sites 43 then contact the SHOG directly to request SRS data, identifying the relevant user in the request. Such identification is conveniently performed by the SHOG supplying the user with a one-time password when the user selects an SRS, this password being forwarded to the web site 43 in the SHOG header sent by the user station 42, and thence from the web site to the SHOG 41 with the SRS request. An advantage of this arrangement is that the amount of traffic the SHOG needs to handle will usually be less since it only needs to serve users for procedures relating to SRSs, and to serve web sites with an active interest in SRS data. In addition, a proprietary SHOG interaction protocol, not necessarily based on HTTP, can be employed more efficiently between the SHOG and web site servers, facilitating response to new data exchange requirements.

It will be seen from the above that embodiments of the invention provide a convenient and effective system allowing Internet users to setup, modify, and share multiple personalized user specifications which can be selected according to users' desired roles and used at multiple web sites. The transfer of user specification data to web sites is transparent to users, the data being supplied automatically without requiring user control to effect the transfer. Web sites can then use the user specification data to customize their site layout, recommendations and promotions according to the user preferences indicated in the specifications. It will be appreciated of course that, while the above embodiments have been described in the particular context of on-line shopping, embodiments of the invention may also be advantageous in other contexts. For example, as an alternative or in addition to the shopping gate, embodiments of the invention could provide an “information gate”, allowing customization of web sites providing access to information, such as news feeds for example, based on the user preferences specified in the user specification. As before, user specifications corresponding to different user roles (professional, hobby, family, etc.) can be maintained and selected for use by the user as appropriate. Many other changes and modifications may be made to the above embodiments without departing from the scope of the invention.

We claim:

1. A method of facilitating customization of information presented by web sites for display to an Internet user based on preferences of the Internet user, the method comprising:
storing, in response to input of the Internet user, a user specification comprising data which indicates, for each of a plurality of predefined preference elements, each of which may have a plurality of predefined values corresponding to respective user preferences, a value corresponding to that user's preference; and
on establishment of a connection by the Internet user to any one of a plurality of web sites, supplying at least some of the user specification data to the web site to allow the information presented for display to the user by the web site to be customized based on the user preferences indicated by the data supplied.

2. The method according to claim 1 including providing a user interface, for display at a user station, for prompting said input of the Internet user.

3. The method according to claim 1 including:
storing a said user specification for each of a plurality of Internet users in response to input of the respective user; and
on establishment of a connection by a said user to any one of said plurality of web sites, supplying to the web site at least some of the user specification data of the user specification stored for that user.

4. The method according to claim 1 including:
storing a plurality of said user specifications in response to input of the Internet user, each of the user specifications representing a different set of user preferences for that user; and
selecting, in response to input of the Internet user, one of said plurality of user specifications for use by that user;
wherein the user specification data supplied to the web site on establishment of said connection is data of the selected user specification.

5. The method according to claim 1 wherein, on establishment of said connection, said user specification data is supplied to the web site in response to receipt from the web site of a user specification request.

6. The method according to claim 5 wherein the user specification request indicates at least one of said predefined preference elements, and wherein the user specification data supplied to the web site in response to said request indicates the value corresponding to the user's preference for that preference element.

7. The method according to claim 1 including:
receiving said input of the Internet user from a remote user station;
establishing said connection in response to receipt from the user station of a web site request corresponding to a said web site;
receiving said information for display to the user from the web site; and
forwarding said information to the user station for display.

8. The method according to claim 1 including:
receiving said input of the Internet user from a remote user station; and
on establishment of said connection, supplying said user specification data to said web site in response to receipt from the web site of a user specification request identifying the Internet user.

9. The method according to claim 1 including updating the user specification in response to information received from a web site indicative of new user preferences expressed during connection of the Internet user to that web site.

10. The method according to claim 1 including;
receiving from a said web site information indicative of user actions during connection of the Internet user to that web site; and
storing user-history data indicative of said user actions in said user specification from which data was supplied to the web site during said connection.

11. The method according to claim 1 including:
associating a security token with the user specification stored for the Internet user; and
on input of the security token by another Internet user and establishment of a connection to a web site by that other user, supplying to the web site at least some of the user specification data of the user specification associated with the security token.

12. A method of customizing information presented by a web site for display to an Internet user based on preferences of the Internet user, the method comprising:
in a customization system connectable to the web site via the Internet, storing, in response to input of the Internet user, a user specification comprising data which indicates, for each of a plurality of predefined preference elements, each of which may have a plurality of predefined values corresponding to respective user preferences, a value corresponding to that user's preference, and, on establishment of a connection by the Internet user to the web site, supplying at least some of the user specification data to the web site; and
at the web site, customizing the information presented for display to the user based on the user preferences indicated by the user specification data supplied by the customization system.

13. An apparatus for facilitating customization of information presented by web sites for display to an Internet user based on preferences of the Internet user, the apparatus comprising memory, communications circuitry for communication of data with web sites, and control logic, the control logic being configured to:
generate, in response to input of the Internet user, a user specification comprising data which indicates, for each of a plurality of predefined preference elements, each of which may have a plurality of predefined values corresponding to respective user preferences, a value corresponding to that user's preference;
store the user specification in said memory; and
on establishment of a connection by the Internet user to any one of a plurality of web sites, supply at least some of the user specification data to the web site via said communications circuitry to allow the information presented for display to the user by the web site to be customized based on the user preferences indicated by the data supplied.

14. The apparatus according to claim 13 wherein the control logic is further configured to supply a user interface, for display at a user station, for prompting said input of the Internet user.

15. The apparatus according to claim 13 wherein the control logic is configured to:
store a said user specification for each of a plurality of Internet users in response to input of the respective user; and
on establishment of a connection by a said user to any one of said plurality of web sites, supply to the web site at least some of the user specification data of the user specification stored for that user.

16. The apparatus according to claim 13 wherein the control logic is configured to:
store a plurality of said user specifications in response to input of the Internet user, each of the user specifications representing a different set of user preferences for that user; and
select, in response to input of the Internet user, one of said plurality of user specifications for use by that user;
the control logic being configured such that the user specification data supplied to the web site on establishment of said connection is data of the selected user specification.

17. The apparatus according to claim 13 wherein the control logic is configured to supply said user specification data to the web site in response to receipt from the web site of a user specification request on establishment of said connection.

18. The apparatus according to claim 17 wherein the user specification request indicates at least one of said predefined preference elements, and wherein the control logic is configured such that the user specification data supplied to the web site in response to said request indicates the value corresponding to the user's preference for that preference element.

19. The apparatus according to claim 13 wherein the control logic is further configured to:
receive said input of the Internet user, via said communications circuitry, from a remote user station;
establish said connection in response to receipt from the user station via said communications circuitry of a web site request corresponding to a said web site;
receive said information for display to the user from the web site; and
forward said information to the user station via said communications circuitry for display to the user.

20. The apparatus according to claim 13 wherein the control logic is further configured to:
receive said input of the Internet user, via said communications circuitry, from a remote user station; and
on establishment of said connection, supply said user specification data to said web site in response to receipt from the web site of a user specification request identifying the Internet user.

21. The apparatus according to claim 13 wherein the control logic is further configured to update the user specification in response to information received from a web site indicative of new user preferences expressed during connection of the Internet user to that web site.

22. The apparatus according to claim 13 wherein the control logic is configured to:
receive from a said web site information indicative of user actions during connection of the Internet user to that web site; and
store user-history data indicative of said user actions in said user specification from which data was supplied to the web site during said connection.

23. The apparatus according to claim 13 wherein the control logic is further configured to:
associate a security token with the user specification stored for the Internet user; and
on input of the security token by another Internet user and establishment of a connection to a web site by that other user, supply to the web site at least some of the user specification data of the user specification associated with the security token.

24. An apparatus for customizing information presented by a web site for display to an Internet user based on preferences of the Internet user, the apparatus comprising:
a customization system connectable to web sites via the Internet, the customization system comprising memory, communications circuitry for communication of data with web sites via the Internet, and control logic configured to generate, in response to input of the Internet user, a user specification comprising data which indicates, for each of a plurality of predefined preference elements, each of which may have a plurality of predefined values corresponding to respective user preferences, a value corresponding to that user's preference, to store the user specification in said memory, and, on establishment of a connection by the Internet user to any one of a plurality of web sites, supply at least some of the user specification data to the web site via said communications circuitry; and
a server system providing one of said plurality of web sites, the server system being arranged, on establishment of a connection by the Internet user to that web site, to customize the information presented for display to the user based on the user preferences indicated by the user specification data supplied by the customization system.

25. A computer program product comprising a computer readable medium having embodied therein computer readable program code means for causing a processor of customization apparatus to perform a method of facilitating customization of information presented by web sites for display to an Internet user based on preferences of the Internet user, the method comprising:
storing, in response to input of the Internet user, a user specification comprising data which indicates, for each of a plurality of predefined preference elements, each of which may have a plurality of predefined values corresponding to respective user preferences, a value corresponding to that user's preference; and
on establishment of a connection by the Internet user to any one of a plurality of web sites, supplying at least some of the user specification data to the web site to allow the information presented for display to the user by the web site to be customized based on the user preferences indicated by the data supplied.
